(19) United States
(12) Patent Application Publication
(10) Pub. No.: US 2011/0231308 A1
(43) Pub. Date: Sep. 22, 2011

(54) Notification and Response System with Financial Tracking Features

(76) Inventors: Ryan Scott Rodkey, Sugar Land, TX (US); John Frank Rodkey, JR., Missouri City, TX (US); David Lynn Hickey, Rosharon, TX (US); Darren Lynn Ross, Sugar Land, TX (US)

(21) Appl. No.: 13/118,508

(22) Filed: May 30, 2011

Related U.S. Application Data
(63) Continuation of application No. 11/500,002, filed on Aug. 7, 2006.
Application No. 11/500,002 is a continuation of application No. 11/132,543, filed on May 19, 2005.
Application No. 11/132,543 is a continuation of application No. 11/111,594, filed on Apr. 22, 2005, now abandoned.

(51) Int. Cl. G06Q 40/00

(52) U.S. Cl. 705/39; 705/35

(57) ABSTRACT

A notification and response system utilizing a processor with dynamic information database and an administrator interface to transmit a financial messages from an administrator to a contact devices for guardians, and others associated with persons in an institution. The database has guardian, employee, and other person contact data, priority information, and response data. The administrator initiates distribution of the financial message based upon priority information and the priority order. The message is transmitted through at least two industry standard protocols simultaneously to guardians, employee, and other persons listed contact devices based upon priority information. Once the financial message is received a response is transmitted back through the two industry standard protocols back to the dynamic information database to insure the financial account is fully funded.

### CROSS REFERENCE TO RELATED APPLICATIONS

The present application is a Continuation of co-pending U.S. patent application Ser. No. 11/500,002, entitled: Notification and Response System with Financial Tracking Features”, filed on Aug. 7, 2006; which claims priority from U.S. application Ser. No. 11/352,543, entitled: “School-Wide Notification and Response System’, filed on May, 2005; which claims priority from U.S. patent application Ser. No. 11/111,594, entitled: “Digital Notification and Response System”, filed on Apr. 28, 2005.

### FIELD

The present embodiments relate generally to the creation and delivery of messages, to the routing, and to the verification and collection of responses to the messages to guardians, employees, and persons associated with an institution, such as a institution or a institution system. The system and methods are universally applicable to, and independent of, the type of messaging system and device selected by the message recipients.

More particularly, the present embodiments relate to a response information or system for guardians, employees, and persons associated with an institution, such as a institution or a institution system relating to person daily finances, which can relate to tracking financial accounts of a person while in an institution or institution system.

### BACKGROUND

Institutions, such as institutions or institution systems, need a system to send and receive information using a variety of messaging formats, systems, and message receiving devices. Often the messages will vary in their level of importance. This could affect the delivery methods and/or the nature and timing of any needed response to the message. For example, the arrival of an e-mail message from a particular sender might cause the recipient to fax a report in response. In some group messaging contexts, the post-message processing, organizing, and reporting of multiple message responses can be important in further decision making by the message originator.

The prior art methods implemented in commercially available unified messaging and device specific systems generally provide one-way delivery, with destinations defined by the sender. Unfortunately, prior art systems do not solve the need for originating a message, with attachment and response requirements, in a manner and format that is independent of the type of the device that is to be used for delivering the message to the recipients.

Also, prior art systems do not permit the message notification methods to be defined by the recipients, and do not include a facility for automatic processing and organization of message responses. Accordingly, known e-mail, unified messaging and specific device systems using these prior art methods are deficient in responding to these requirements.

A need exists for a system and method for automating and escalating the delivery of messages and collection of message responses implemented through messaging devices of multiple types particularly with regard to a financial crisis of a person The system needs to work in conjunction with recipient rules routing, verification of notification and response, and collection of responses in a predefined format.

A need exists for a method of communication from an administrator which reaches all possible forms of communication devices, so that all members of the designated user groups can be reached.

A need exists for a system that can transmit a message in multiple languages to multiple user devices to inform the public of emergency situations, and general information simultaneously.

The present embodiments meet these needs.

### BRIEF DESCRIPTION OF THE DRAWINGS

The detailed description will be better understood in conjunction with the accompanying drawings as follows:

FIG. 1 depicts a representation of an overall embodiment of a digital notification and response system for handling financial accounts.

FIG. 2 depicts a representation of embodiment of a financial accounts database associated with a notification and response system.

FIG. 3 depicts a representation of an embodiment of an administrator interface usable in the notification and response system.

FIG. 4 depicts a representation of a message usable with the notification and response system.

The present embodiments are detailed below with reference to the listed Figures.

### DETAILED DESCRIPTION OF THE EMBODIMENTS

Before explaining the present embodiments in detail, it is to be understood that the embodiments are not limited to the particular embodiments and that the invention can be practiced or carried out in various ways.

The present embodiments relate to an immediate response information or system for a institution, such as a school or an institution system such as a hospital system or hospice system. An institution can be an established organization or foundation, especially one dedicated but not limited to education, public service, medical services or hospitality services. The embodied methods provide better communication with guardians, students, employees of the institution, or persons other than students in an institution, such as a patient, about their financial accounts without using a conventional telephone. This enables patients and others to be assured of having funds for a meal or needed medications, that otherwise would be delayed or not provided due to insufficient funds.

The embodied methods provide a communication system that ensures guardians, employees, and persons enrolled in an institution to be contacted simultaneously through two standard industry protocols, to a chosen first guardian contact device, and then a second such device if the first device does not respond, The devices are selected by the guardian, employee or person in the institution and can be devices that receive email, or cellular phone calls, such as a cellular phone, or a Blackberry™ to provide up to the minute details when a financial crisis has occurred.

The present embodiments relate to a system that can be used for both emergency use and for improved communication between guardians, employees, and persons in a institution concerning their funds.

The embodied methods and systems can be used to provide information updates to guardians, employees and persons in the institution in real time, concerning their funds, so that a child, or a person enrolled in an institution has money to pay for meals.

The embodied methods can be used to contact a credit card company to authorize a charge or a bank to wire in funds to fill a financial account.

These embodiments are designed to prevent hunger in the institutions which impedes learning and other harmful situations. The embodiments are to insure the money is there for lifesaving blood transfusions, and needed medications for a patient to survive if they have no insurance or their funds are low.

In this embodiment, the administrator interface includes a “call me” feature enabling an administrator to record a message for delivery and a financial tracking feature for tracking individual persons financial accounts.

The system uses a dynamic information database (DID), to monitor, collect, and react to real time situations when current funds in a financial account are low, such as an account for students with prepaid lunches at a school, even if the prepaid lunches are funded by guardians, government agencies, or social agencies.

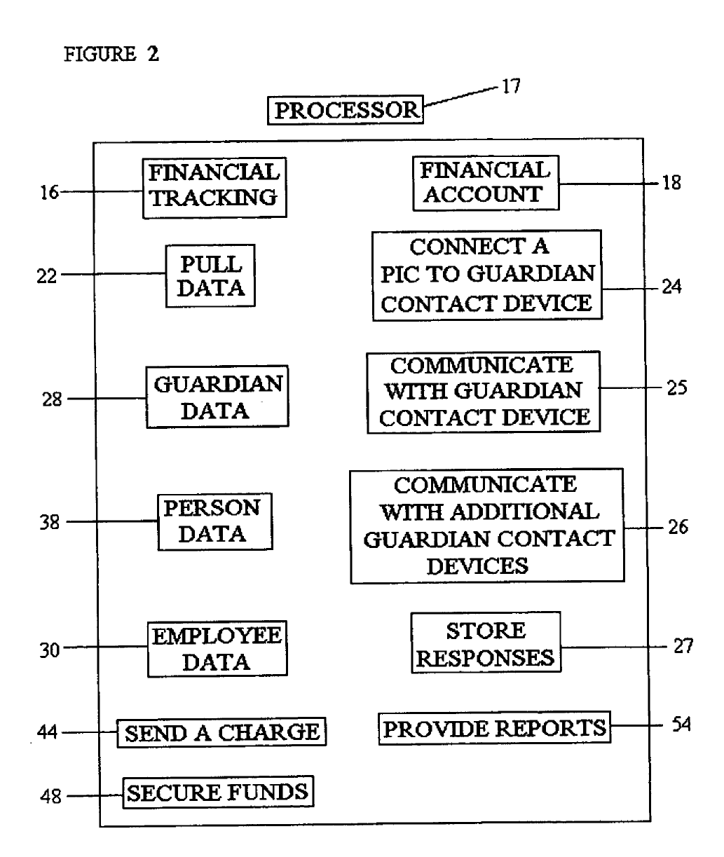

The embodiment includes a processor with data storage having computer instructions to instruct a processor to undertake many steps as will be discussed in FIG. 2.

The system can maintain a current database of contact information for guardians, employees, and persons. In the context of the present application, the term “guardians” refers to an individual or agency, or other business legally responsible for the care and management of a person in an institution, including a minor in a school or an elderly person in a nursing home.

In this embodiment, the administrator initiates distribution of the financial message using the guardian data, employee data, person data, and grouping information, wherein the message is transmitted through at least two industry standard protocols simultaneously, and the message is received by at least one guardian contact, an even by at least one person contact device, and even by at least one employee contact device. The guardian contact device, person contact device, employee contact device transmit responses back through the industry standard protocols simultaneously to the dynamic information database where those responses are stored for use in generating reports or other alerts.

With the scope of this application, the term “employee” refers to teachers and other faculty, coaches, contractors to the institution, principals, secretaries, superintendents, doctors, nurses, directors of nursing homes, consultants to the institutions, institution board members, coordinators, security personnel, emergency personnel, counselors, maintenance personnel, and other individuals that work on the facility, in the facility, or in conjunction with institution activities.

The present embodiments relate to the creation and delivery of messages, and to the routing of those messages and to the verification and collection of responses to the messages. The messages are initially directed at guardians, but can also be directed to employees of the institution and persons in the institution.

The present embodiment relates to the simultaneous transmission of a message in multiple languages to a user contact device, wherein the recipient of the message selects the language for transmission to the recipient.

The embodied immediate response information system provides a timely and uniform manner to contact numerous users through numerous user contact devices, such as a cell phone, a television, a light emitting diode “LED” display, a land phone line, an e-mail address, a fax machine, a pager, a digital display, similar devices, and handheld wireless device, including personal digital assistants “PDA's” and a Blackberry™.

The system is used to contact guardians, persons, and employees in the case of informational situations, such as field trips, special lunch plans, where food needs to be unexpected paid for such as a holiday parties, or any additional event, which can require a child or person in an institution to provide funds.

The present embodiments provide a system that has a high speed notification and response system to contact a large number of guardians in a systematic manner based upon priority.

The embodied immediate response information systems provide other benefits, such as general information update. For example, a message can be sent such as “bring lunch money for the field trip to the zoo today” to all guardians or persons in a sixth grade class using the system.

To operate the system, a school principal goes to his computer, clicks on a web browser, and clicks on the site that contains the administrator interface, such as “irisdispatch.com”.

The site is the administrator interface used to transmit the message to the guardians, employees, and persons via a contact device.

Once the web interface comes up, the principal enters the site using with a user name and a password, such as, user name Jerry Spears, password: 123jsp. The principal types in the message

Once the message is entered, the principal presses the send button. The system proceeds automatically to do the following:
a. The system identifies that the guardians of the persons in the sixth grade of the institution are the first priority group for this type of message. The system transmits the message to each guardian's contact device based upon the contact information in the database.
b. The system identifies that the persons are the second priority group for this type of message. Likewise, system transmits the message to each person contact device based upon the contact information in the database.
c. The system continues to contact groups based upon priority groupings for this type of message.
d. Each contact device returns a response that the information has been received. The database stores the information into a database for report generation on demand.
e. The system continues to transmit the message to contact devices that have not responded until all contact devices have received the message or until the principal ends the transmission.

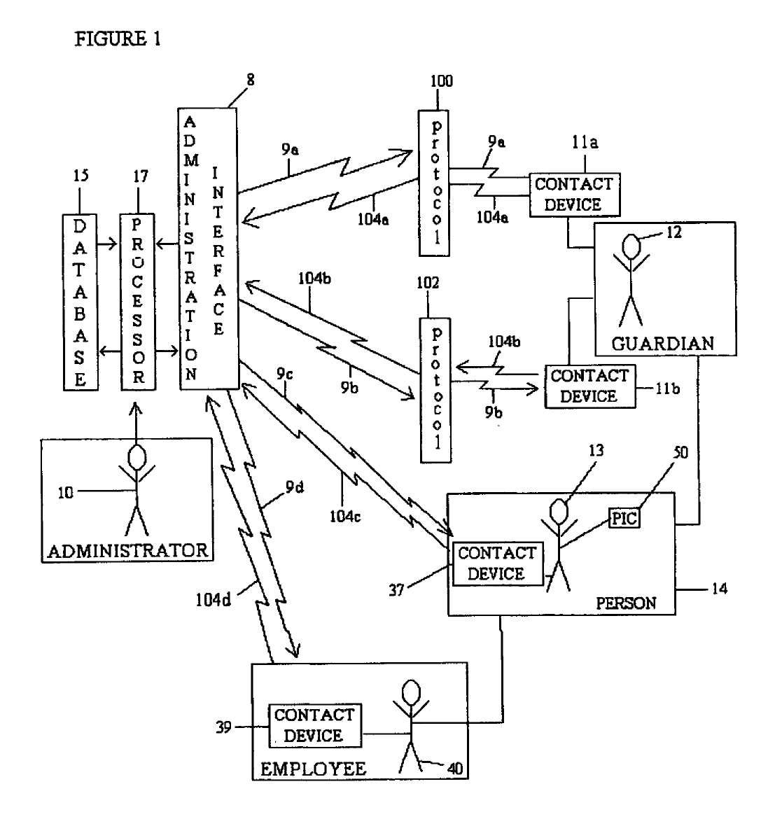

With reference to the figures, FIG. 1 shows an example of an embodiment of the digital notification and response system.

The digital notification and response system of FIG. 1 shows an administrator interface (8) for transmitting a message (9a, 9b, 9c and 9d) from an administrator (10) to at least one guardian contact device (11a and 11b) of a guardian (12) or to a person contact device (37) of a person (13) in an institution (14) or to an employee contact device (39) of an employee (40) of an institution using a processor (17).

The processor (17) is in communication with a dynamic information database (15).

The guardian contact devices (11a and 11b) corresponds to a guardian (12) of the person (13) in the institution (14).

The administrator (10) initiates distribution of the message (9a, 9b, 9c, and 9d) using guardian data stored in the dynamic information database (15). The message is transmitted through at least two industry standard protocols (100 and 102) simultaneously.

The message is received by at least one guardian contact device, and/or the contact device for the person in the institution, or the contact device for the employee associated with the institution.

The contact devices transmit responses (104a, 104b, 104c, and 104d) through the industry standard protocols simultaneously to the dynamic information database.

It should be noted that the person (13) in the institution (14) could have a personal identification code (PIC) (50) which facilitates identification of a fund account tracked by the database to a particular person.

The dynamic information database (DID) is shown in more detail in FIG. 2. The DID has computer instructions for financial tracking (16) that instruct the processor (17) to track at least one financial account (18) that corresponds to at least one person in the institution, who may additionally have a PIC.

The DID also includes computer instructions to instruct the processor to pull data (22) from the files or data in the DID when a financial account falls below a preset limit, such as $50.00 United States Dollars.

The DID includes computer instructions to instruct the processor to connect a personal identification code (PIC) with at least one guardian contact device (11a or 11b).

The DID has computer instructions to instruct the processor to communicate with an initial guardian contact device when the financial account falls below a preset limit (25).

The DID includes computer instructions for instructing the processor to contact an additional guardian contact devices (26), sequentially and based on a priority order, when an error response is returned from the initial guardian contact device.

Further the DID has computer instructions for instructing the processor to store responses (104a, 104b, 104c, and 104d) from the guardian contact device and/or the employee contact device, and/or the person in the institution's contact device (27).

The responses can indicate which guardian and/or employee, and/or person in the institution contact devices have received the messages and which have provided error in response information indicating insufficient contact device information for the guardian, or person, and/or person contact device.

The DID also stores data, including guardian data (28) which includes guardian user contact device information and guardian priority information that indicates a contact order for the guardian contact devices.

The DID also stores employee data, (30) which includes employee user contact device information and employee priority information that indicates a contact order for the employee contact devices.

The DID stores person in the institution data (38) which includes a person in the institution user contact device information and a person in the institution priority information that indicates a contact order for the person in the institution's contact devices.

The DID includes computer instructions instructing a processor to send a charge (44) to a credit card or a debit card to fill the financial account to a predesignated limit when the financial account falls below a preset limit

The DID includes computer instructions instructing a processor to secure funds (48) or the financial account using an ACH (Automatic Clearing House) bank draft.

As shown still in FIG. 2, the DID (15) includes computer instructions for instructing the processor (17) to provide reports (54) on the financial account (18) for administrators, guardians, persons in the institutions, or combinations thereof. The reports can be customized reports or standardized reports.

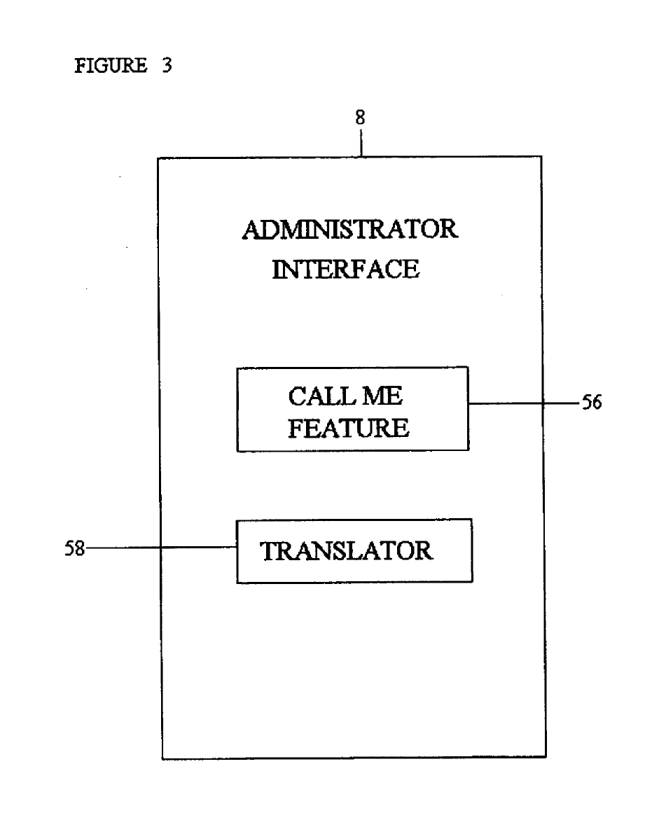

FIG. 3 shows the administrator interface (8) with the “call me” feature (56) enabling the administrator to record the message for delivery to at least one guardian contact device, and/or to the employee contact device, and/or to the person in the intuition's contact device.

Returning to FIG. 1, the administrator interface (8) communicates with the processor (17) and the dynamic information database (15) using computer instructions (20). The administrator interface (8) has a “call me” feature (56) which is a control device, that enables an administrator, guardian, employee, or person to call into the system and communicate via the administrator interface (8). As part of the administrator interface (8), a translator (58) exists, either at the institution or electronically to record messages in real time with user selected languages. The administrator interface (8) can use the “call me” feature (56) enabling a administrator (10) to record a message for delivery to the appropriate contact devices.

Examples of usable contact devices include handheld wireless devices, wireless phones, land phones, e-mail addresses, digital displays, LED display, fax machines, pagers, and similar devices that capable of receiving a message. An example of a handheld device includes a PDA, a Blackberry™, a cellular phone or combinations thereof.

The administrator interface (8) can be a local area network interface, a wide area network interface, a virtual private network interface, asynchronous transfer mode interface, synchronous optical network interface, a call center, a voice mail, or other similar means to transmit a message to numerous contacts.

The accounts can be funded by guardians, government agencies, social agencies, or the like.

An embodiment contemplates that a plurality of person identification codes correspond to a single guardian.

An embodiment contemplates that the financial account can be used to pay at least one fee for the person in the institution. That fee can be an library overdue book fine, fees for field trips, fees for science lab projects, fees for sports uniforms, fees for sports equipment, fees for doctors and nurses, fees for medications, fees for recreational trips, after school program fees, or combinations thereof.

The institution can be a school, a mental hospital, a hospice center, a nursing home, an assisted, retirement communities, and so forth.

Still another embodiment contemplates that the message can be emitted automatically by the processor via the administrator interface when all the financial account falls below preset limits.

Yet another embodiment contemplates that herein the response from the contact devices can be an audio file or a dual-tone multi-frequency “DTMF” tone.

The system can operate on a local area network web interface, a wide area network web interface, virtual private network interface, asynchronous transfer mode interface, synchronous optical network interface, a call center interface, a voice mail, or combinations thereof.

The administrator can be a person, a computer, another digital notification and response system, an analog notification system, or combinations thereof.

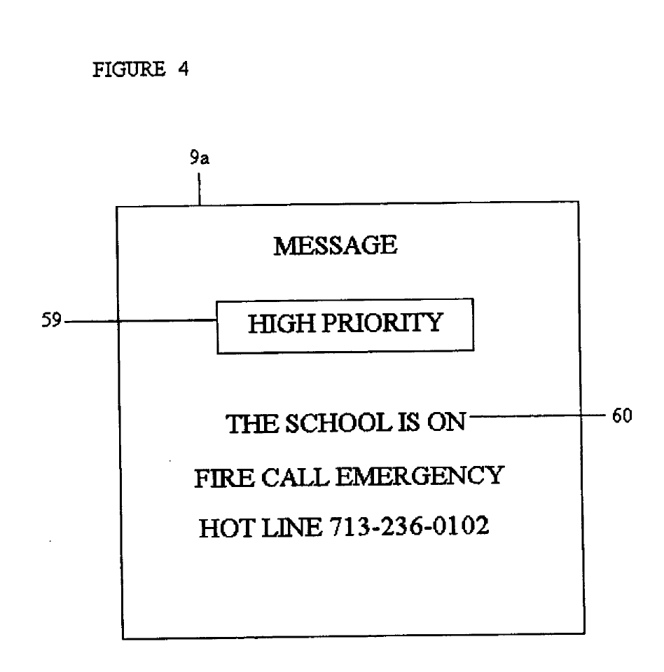

The message can have a designation (59) shown in FIG. 4. The designation can be a low priority, general priority, significant priority, high priority, and severe priority. The text of the designation can be a color associated with the priority. FIG. 4 shows the background of the message, as colored red with the element (60).

The dynamic information database can be an SQL™ database, MySQL™ database; other industry standard databases, an Oracle™ database, or combinations thereof.

The industry standard protocol could be two of the following: a Megaco/H.248 protocol, Simple Message Transfer Protocol (SMTP) protocol, a Short Message Service (SMS) protocol, Multimedia Message Service (MMS) protocol, a Enhanced Message Service (EMS) protocol, a Media gateway Control Protocol (MGCP), a SIP protocol, a H.323 protocol, an ISDN protocol, a PSTN protocol, and combinations thereof.

In an exemplary embodiment, each guardian contact device corresponds to a guardian of a person in a nursing home or guardian of a child in a school, each employee contact device corresponds to an employee of the institution, and each person contact device corresponds to a person in the institution. For example, person Betty has a person user device or cell phone, her mother, the guardian, Joan has a pager, her Dad, another guardian Bill has a Laptop, and her teacher, an employee of the school, Miss Rosa, has a Blackberry™.

In this embodiment, as shown in FIG. 3, the administrator interface includes a “call me” feature (56) enabling an administrator to record a message for delivery and a financial tracking feature for tracking individual persons financial accounts, whether they have sufficient funds or insufficient funds.

The computer instructions instruct the processor to communicate with guardian contact devices and/or an employee contact device if a person is lacking in financial funds. The computer instructions further instruct the processor to further contact an additional guardian contact device where there is no response to the communication with a first guardian contact device, and the computer instructions can store responses from the guardian contact devices or the employee contact device.

The message is a text message, a numerical message, with one or more images, or a combination of these. The message can be encoded.

The message can be coded green for a low priority message, blue for a preparedness message or general priority message, yellow for a cautionary message such as a significant priority, orange for an emergency message or high priority message, or red for a critical message with a severe priority. These priority levels can be customized and tailored to standards for a particular institution, such as a institution or institution system. The messages and priority codes can be prewritten and stored in the dynamic information database for subsequent use of the administrator.

In some cases, more than one person in the institution is in the care of the guardian. This system works where there is more than one person in the institution and only 1 account, or multiple accounts and multiple people but only one or two guardians.

Additionally, the system works when an older sister or older brother in the institution is required to take care of a younger child in the institution, this system enables the older child to be notified immediately of a low fund situation in case they can help out.

The message can be stored on the dynamic information database at a location remote to the institution.

The message can be a prewritten message stored in the dynamic information database for subsequent use by the administrator or can be generated from the dynamic information database based upon inputs from the administrator and transmitted using the administrator interface.

A user selected language can be indicated for the message.

A user, wherein at least one person enrolled in an institution has a personal identification code “PIC” which corresponds to a bar bard, a radio frequency identification device “RFID” tag, a scannable badge, a smart card, a security token, a biometric file, and combinations thereof.

An additional embodiment can include an interactive voice response “IVR”. In this embodiment a IVR can be a computerized system that allows a person, such as a telephone caller, to select an option from a voice menu and otherwise interface with the computer system.

The contact device information can include an e-mail address, an internet protocol (IP) address, a phone number, a pager number, and combinations thereof. The contact device information can further include a name, an address, a phone number, a device address, a social security number, an account code, and combinations thereof. Each contact device can include information that is unique to each individual guardian, employee and/or person contact devices or can include information that is common to all contact devices. For example, a serial number for a cell phone, a Mac™ address for an Ethernet card, an IP address, and so forth.

The contact data can include priority order, which provides the benefit of ensuring that the most critical guardians, employees, and persons receive the message first in case time is not available to contact all of the users. The priority order also provides the benefit that all guardians, employees, and persons get contacted with equal priority, rather than a discriminating message delivery priority. The priority order guarantees that all users get contacted to on a preferred device first.

By grouping guardians and employees, the system provides the benefit of more efficient delivery of information without having to treat each user individually. Grouping more efficiently defined message recipients speeds the delivery of the message.

The predefined group can be identified by the administrator or by another user in advance to sending the message. Examples of groupings include guardians of a second grade class, or other similar groupings.

The grouping information can include at least a first group associated with each guardian user contact device and at least a second group associated with each employee user contact device, a guardian priority order for contacting each guardian user contact device within the group and an employee priority order for contacting each employee user contact device within the group.

The grouping information further includes a priority order for contacting each guardian and employee within the group, such as parents first, teachers second. The priority order directs the administrator interface as to the order in which the interface should contact the individual contact devices.

The guardian data, employee data, and person data can be a user name, a user address, a user phone number, a user device residential address, a social security number, an account code, an employee identification number, a person identification number, and combinations thereof.

Person data (62) can include person priority information that indicates a contact order for the person contact device and can include a person identification number which may correspond to a bar code, a radio frequency identification device or “RFID” tag, a scannable badge, a smart card, a biometric file, and combinations thereof.

Other guardian, employee, and person data can include but is not limited to: person address, guardian address, employee address, grade level, employee position, phone extensions, person name, employee name, guardian name, latitude, longitude, geocode, birth date, social security number, employee id, person id, institution level, institution name, institution phone number, institution address, and combinations thereof.

The message as noted above can be transmitted through at least two industry standard protocols simultaneously. By transmitting the message through numerous protocols, the system provides redundancy in order to ensure the message is relayed to the guardians, employees, and person.

The priority information and order directs the administrator interface to contact a first group of contact devices, for this example, the guardian contact device indicated as a first contact. After all of the contact devices in the first contact have received the message, the priority order directs the administrator interface to contact a second group of contact devices, for this example, the employee contact device indicated as a second contact. Then, the administrator interface continues to relay messages to contact devices based on the priority order until all contact devices are reached and a response is provided from the contact devices. The priority order of the user devices is selected by the user.

Once the message is received by a contact device, the contact device transmits a response back through the industry standard protocols to the dynamic information database. The dynamic information database stores the responses and the unique address of each user contact device.

The reports can include a date the message was sent, a time the message was sent, a date the message was received, a time the message was received, content of the message, whether whole or partial, a recipient of the message, recipient information related to the recipient of the message, and combinations thereof, which can be in the form of guardian response information, employee response information, and/or person response information, and provide an “error-in-response” information to make sure all contact devices are working properly, or if the guardians, employees, and persons must be contacted for additional information or working numbers. Other examples include the name of the person who received the message, a copy of the voice mail, a time when an e-mail was accessed, the time when a fax is printed and so on. The administrator can create custom designed reports, or standard reports can be generated from the dynamic information database for use by the administrator.

Reporting includes generating custom designed financial reports created by the administrator, or generating standard reports generated from the dynamic information database using preconceived templates or combinations thereof.

The reports are contemplated to have a date the message was sent, a time the message was sent, a date the message was received, a time the message was received, content of the message, a recipient of the message, recipient information for the message, and combinations thereof.

In an alternative embodiment, the system can include a language converter to translate a text message to second language. The language converter is often referred to as a translator. For example, the language converter can convert the message from English to a second language, such as Korean, Chinese, Vietnamese, French, English, Spanish, Italian, Norwegian, Swedish, German, Japanese, Russian, or Portuguese.

The language converter is beneficial because not all users speak the same language, thereby causing a breakdown in the communication between groups of people due to language. The system allows the user to designate a specific language in which to receive the message. The chosen language is stored in the dynamic information database as the user selected language.

In an alternative embodiment, the system can include a text-to-sound file converter. The text-to-sound file converter can be used to translate a message from text to a sound file. The text-to-sound file converter is beneficial because the message is consistent using the same voice, with the same accent, same dynamic, and same delivery speed. The text-to-sound file converter enables individuals with disabilities, namely visual impairment, to also receive the consistent message.

The claimed notification and response system provides quick delivery speed. The system can send alert messages to thousands of recipients in about thirty seconds with the click of a single mouse.

The claimed notification and response system provides format and message flexibility. The response system can reach numerous recipients on numerous types of contact devices virtually at the same time. For example, the system can contact telephones, cell phones, digital pagers, fax machines, wireless PDA devices, email systems, computer system tray icons, Amber alert systems, and LED signs.

Voice and text can be delivered in numerous languages as specified by recipients. The system can enable guardians of persons who do not speak English well to be notified and act on an emergency message enabling immigrant families to act quickly as well as native English speaking families. Since the claimed system solves the language barrier problems, the system is vital to states that have large non-English speaking family populations, such as Texas, California, and Florida.

The embodied system provides message consistency. The notification system can be used to deliver exactly the same message to all recipients to prevent confusion and rumor control.

An embodiment contemplates that a message is transmitted automatically to the users when a person's funds fall below preset limits.

The embodiments have been described in detail with particular reference to certain embodiments, thereof, but it will be understood that variations and modifications can be effected within the scope of the embodiments, especially to those skilled in the art.

What is claimed is:

1. A digital notification and response system, comprising:
a. an administrator interface for transmitting a message from an administrator to at least one guardian contact device using a processor in communication with a dynamic information database, wherein the at least one guardian contact device corresponds to a guardian of a person in a institution, wherein the database comprises:
(i) computer instructions for financial tracking that instruct a processor to track at least one financial account corresponding to at least one person in the institution;
(ii) computer instructions to instruct the processor to pull data from the database when an account is below a preset limit;
(iii) computer instructions to instruct the processor to connect a personal identification code (PIC) with at least one guardian contact device;
(iv) computer instructions to instruct a processor to communicate with an initial guardian contact device concerning the account falling below the preset limit;
(v) computer instructions for instructing the processor to contact an additional guardian contact device when an error response occurs with the initial guardian contact device;
(vi) computer instructions for instructing the processor to store responses from the guardian contact device; and wherein the responses comprise guardian response information (34) indicating which guardian contact devices have received the message and error in response information (36) indicating insufficient contact device information exists for the guardian contact device; and
(vii) guardian data comprising:
1. guardian user contact device information; and
2. guardian priority information that indicates a contact order for the guardian contact device;
wherein the administrator initiates distribution of the message using the guardian data, wherein the message is transmitted through at least two industry standard simultaneously, and the message is received by at least one guardian contact device and wherein at least one guardian contact device transmits a response through the industry standard protocol to the database.

2. The system of claim 1, further comprising at least one person in the institution contact device for receiving the message directed to the person in the institution and providing a response, using person data stored in the dynamic information database, wherein the person data comprises: person user contact device information and person priority information that indicates a contact order for the person contact device.

3. The system of claim 1, further comprising at least one employee contact device for receiving the message directed at an employee of the institution, using employee data stored in the dynamic information database and providing a response for an employee of the institution wherein the employee data comprises employee user contact device information and employee priority information that indicates a contact order for the employee contact device.

4. The system of claim 1, wherein the administrator interface comprises a “call me” feature enabling the administrator to record the message for delivery to the at least one guardian contact device.

5. The system of claim 1, wherein the account information comprises real time information on current account status.

6. The system of claim 1, wherein the accounts are funded by guardians, government agencies, or social agencies.

7. The system of claim 1, wherein the database further comprises employee data comprising employee contact device information and employee priority information that indicates a priority contact order for each employee contact device.

8. The system of claim 3, wherein the employee response indicates the employee contact devices that received the message and error in response information indicating insufficient contact device information exists for the employee contact device.

9. The system of claim 1, further comprising computer instructions instructing a processor to send a charge to a credit card or a debit card to fill the financial account to a predesignated limit when the financial account falls below a preset limit.

10. The system of claim 1, further comprising computer instructions instructing a processor to secure funds for the financial account using an ACH (Automatic Clearing House) bank draft.

11. The system of claim 1, wherein the least one person enrolled in an institution has a personal identification code (PIC).

12. The system of claim 11, wherein a plurality of person identification codes correspond to a single guardian.

13. The system of claim 1, wherein the financial account can be used to pay at least one fee for the person in the institution.

14. The system of claim 1, wherein the institution is A member of the group consisting of: a school, a mental hospital, a hospice center, a nursing home, a retirement community, or an assisted living center.

15. The system of claim 12, wherein the at least one fee comprises a member of the group: library overdue book fines, fees for field trips, fees for science lab projects, fees for sports uniforms, fees for sports equipment, fees for doctors and nurses, fees for medications, fees for supplies, fees for recreational trips, after school program fees, or combinations thereof.

16. The system of claim 1, further comprising computer instructions for instructing the processor to provide reports on the financial account for administrators, guardians, persons in the institutions, or combinations thereof.

17. The system of claim 1, wherein the reports are customized or standardized.

18. The system of claim 1, wherein the message is emitted automatically by the processor via the administrator interface when all the financial account falls below preset limits.

19. The system of claim 1, wherein the response from the guardian contact device, or employee contact device is an audio file or a dual-tone multi-frequency “DTMF” tone.

20. The system of claim 11, wherein the PIC corresponds to a bar code, a radio frequency identification device (RFID) tag, a scannable badge, a smart card, a security token, a biometric file, and combinations thereof.

21. The system of claim 1, wherein the network is a local area network web interface, a wide area network web interface, virtual private network interface, asynchronous transfer mode interface, synchronous optical network interface a call center interface, a voice mail, or combinations thereof.

22. The system of claim 1, wherein the administrator is a person, a computer, another digital notification and response system, an analog notification system, or combinations thereof.

23. The system of claim 1, wherein the message comprises a designation selected from the group: low priority, general priority, significant priority, high priority, and severe priority.

25. The system of claim 24, wherein the designation comprises a color associated with the priority as background of the message and text of the message.

26. The system of claim 1, wherein the message is a prewritten message stored in the dynamic information database for subsequent use by the administrator.

27. The system of claim 1, wherein the dynamic information database is an SQL™ database, MySQL™ database; other industry standard databases, an Oracle™ database, or combinations thereof.

28. The system of claim 1, wherein the industry standard protocol is selected from the group: a Megaco/H.248 protocol, Simple Message Transfer Protocol (SMTP) protocol, a Short Message Service (SMS) protocol, Multimedia Message Service (MMS) protocol, a Enhanced Message Service (EMS) protocol, a Media gateway Control Protocol (MGCP), a SIP protocol, a H.323 protocol, an ISDN protocol, a PSTN protocol, and combinations thereof.

29. The system of claim 1, wherein the contact devices are handheld wireless device from the group: a wireless phone, a land phone, an email address; a fax machine, a pager, a digital display, a light emitting diode “LED” display, or combinations thereof.
